(19) United States
(12) Patent Application Publication
(10) Pub. No.: US 2008/0089250 A1
(43) Pub. Date: Apr. 17, 2008

(54) Transmission Control Method for Tcp Bi-Directional Transmission In Asymmetric Bandwidth Pre-Allocated Subscriber Network And Apparatus Therefor

(76) Inventor: Young-Ha Jung, Gyeonggi-do (KR)

Correspondence Address: THE FARRELL LAW FIRM, P.C., 333 EARLE OVINGTON BOULEVARD, SUITE 701, UNIONDALE, NY, 11553, US

(21) Appl. No.: 11/908,089

(22) PCT Filed: Mar. 10, 2006
(86) PCT No.: PCT/KR06/00871

§ 371 Date: Sep. 7, 2007

(30) Foreign Application Priority Data
Mar. 10, 2005 (KR) 10-2005-0020102

(51) Int. Cl. H04L 5/14

(52) U.S. Cl. 370/276

(57) ABSTRACT

A transmission control apparatus for improving PCT bi-directional transmission performance in an end node or gateway node of an asymmetric bandwidth pre-allocated subscriber network. The transmission control apparatus includes a TCP classification module for acquiring a TCP ACK packet to be transmitted over an uplink during bi-directional transmission; a band-width estimation/prediction module for estimating bandwidth of a downlink corresponding to the uplink at a time when the ACK packet is acquired, predicting following bandwidth of the downlink according to the estimated bandwidth, and calculating a optimal window size of the downlink such that the predicted bandwidth maintains residual bandwidth enough to allow transmission of an ACK packet over the downlink link compared with the maximum bandwidth allocated to the downlink; and a controller for inserting the calculated optimal window size as a reception window size included in the ACK packet and delivering the ACK packet to a destination node.

### PRIORITY

This application is a U.S. National Stage filing of International application PCT/KR2006/00871 that claims priority to an application entitled “Transmission Control Method for TCP Bi-Directional Transmission in Asymmetric Bandwidth Pre-Allocated Subscriber Network and Apparatus Therefor” filed in the Korean Industrial Property Office on Mar. 10, 2005 and assigned Serial No. 20102-2005, the contents of both of which are hereby incorporated by reference.

### BACKGROUND OF THE INVENTION

1. Field of the Invention

The present invention relates generally to an asymmetric subscriber network, and in particular, to a transmission control method and apparatus for improving bidirectional simultaneous transmission performance of a Transport Control Protocol (TCP) in an end node or a gateway node of a subscriber network with an asymmetric bandwidth link.

2. Description of the Related Art

Wideband Code Division Multiple Access (WCDMA), Asymmetric Digital Subscriber Line (ADSL) and Wireless Broadband Internet (WiBro) are subscriber networks that pre-allocate bandwidths for an uplink and a downlink. The subscriber networks generally use TCP to transmit packets over the Internet, and the TCP may cause the following problems because it is basically designed without taking into account the situation where bandwidths are pre-allocated.

A common subscriber network determines an available bandwidth for each individual subscriber during the subscriber's subscription or connection. For example, in WCDMA, a Quality-of-Service (QoS) class and an uplink/downlink maximum bit rate for packet service are determined during the subscription, and the available bandwidth resources, which are allocated each time the subscriber attempts a call, are limited by the QoS class and the maximum bit rate.

In packet service over the Internet, the amount of downlink packet traffic transmitted from a network to a subscriber terminal is in most cases much greater than the amount of uplink packet traffic. Therefore, subscriber networks of various types allocate more bandwidth for the downlink, rather than for the uplink, to efficiently use the limited bandwidth, and such subscriber networks are referred to as asymmetric subscriber networks. For example, in WCDMA, a subscriber can simultaneously perform uploading and downloading at 64 Kbps in the uplink and 384 Kbps in the downlink.

However, in TCP data transmission, an asymmetric bandwidth link may suffer severe performance degradation, especially during bidirectional transmission. Specifically, the occurrence of an ACKnowledge (ACK)-clocking in which an ACK for downlink transmission data is delayed by uplink transmission data, causes a downlink data rate to drop down to a level of the uplink data rate.

For example, a gateway node of the network continuously transmits downlink packets to a subscriber node without an ACK within a predetermined window, and then waits for an ACK for the downlink packets. However, the subscriber node delays transmission of the ACK for the downlink packets to preferentially transmit uplink packets. As a result, the packets for uplink data transmission are filled in a transmission buffer of the subscriber node, preventing the ACK for the downlink packets from being transmitted in time. This causes the data rate of the downlink to drop down to a level of the data rate of the uplink.

Therefore, in supporting bidirectional TCP transmission in the asymmetric bandwidth link, there is a need for a technology for preventing a data rate of one link from decreasing due to a data rate of the other link.

### SUMMARY OF THE INVENTION

To substantially solve at least the above problems and/or disadvantages, the present invention provides a method and apparatus for preventing degradation of TCP uplink/downlink simultaneous transmission performance in an asymmetric bandwidth link.

The present invention further provides a method and apparatus for preventing degradation of TCP simultaneous transmission performance in a gateway node or an end node.

According to one aspect of the present invention, there is provided a transmission control method for bidirectional simultaneous transmission of a transport control protocol (TCP) in a subscriber network with asymmetric bandwidth links. The method includes acquiring a TCP acknowledgement (ACK) packet to be transmitted over a reverse link during bidirectional simultaneous transmission; estimating a bandwidth of a forward link mapped to the reverse link at the time when the ACK packet is acquired; predicting a next bandwidth of the forward link according to the estimated bandwidth, and calculating an optimal window size of the forward link such that the predicted bandwidth maintains a residual bandwidth enough to allow transmission of an ACK packet over the forward link, compared with the maximum bandwidth allocated to the forward link; and inserting the calculated optimal window size as a reception window size included in the ACK packet and delivering the ACK packet to a destination node.

According to another aspect of the present invention, there is provided a transmission control apparatus for bidirectional simultaneous transmission of a transport control protocol (TCP) in a subscriber network with asymmetric bandwidth links. The apparatus includes a TCP classification module for acquiring a TCP acknowledgement (ACK) packet to be transmitted over a reverse link during bidirectional simultaneous transmission; a bandwidth estimation/prediction module for estimating a bandwidth of a forward link mapped to the reverse link at the time when the ACK packet is acquired, predicting a next bandwidth of the forward link according to the estimated bandwidth, and calculating an optimal window size of the forward link such that the predicted bandwidth maintains a residual bandwidth enough to allow transmission of an ACK packet over the forward link, compared with the maximum bandwidth allocated to the forward link; and a rate control module for inserting the calculated optimal window size as a reception window size included in the ACK packet and delivering the ACK packet to a destination node.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram schematically illustrating a configuration of a WCDMA network to which the present invention is applied;

FIG. 2 is a message flow diagram illustrating a PDP context activation procedure;

FIG. 3 is a diagram illustrating a format of a header used in an IP-based TCP;

FIG. 4 is a diagram illustrating a structure of a gateway node according to a preferred embodiment of the present invention;

FIGS. 5A and 5B are flowcharts illustrating an operation of a gateway node according to a preferred embodiment of the present invention; and

FIGS. 6 and 7 illustrate a change in uplink/downlink data rate in the prior art and the present invention, respectively.

### DETAILED DESCRIPTION OF EXEMPLARY EMBODIMENTS

A detailed description of a preferred exemplary embodiment of the present invention will now be described with reference to the accompanying drawings. In the following description, a detailed description of known functions and configurations incorporated herein has been omitted for clarity and conciseness. In addition, the terms used herein are defined taking into account their functions and may be subject to change according to user, operator's intention and the practice. Therefore, the definition should be made based on the details given in the specification.

The present invention is related to the transmission of packets at a data rate not exceeding a predetermined threshold in each of uplink and downlink transmission directions, and the transmission of an ACK in the opposite direction through the remaining bandwidth. In this way, the present invention guarantees a fixed data rate even during simultaneous transmission without being affected by ACK transmission in each direction.

In the following description, WCDMA is used as an example of a bandwidth pre-allocated subscriber network to which an embodiment of the present invention is applied. To this end, a description will now be made of each node and details of the WCDMA network.

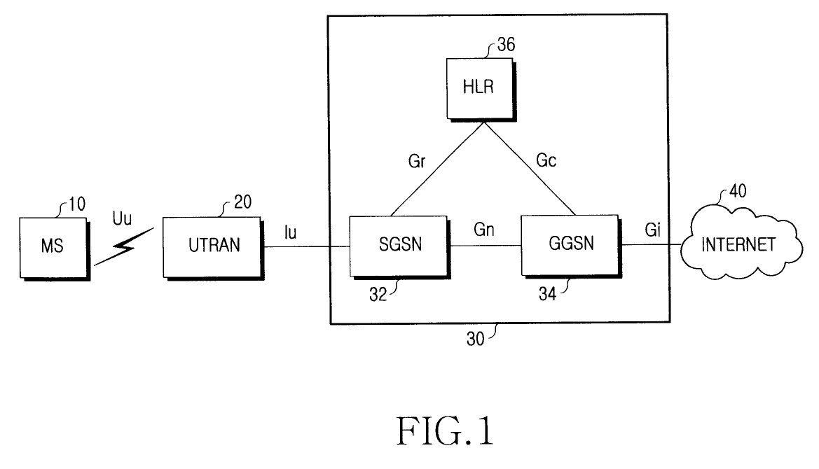

FIG. 1 is a diagram illustrating a configuration of a WCDMA network to which the present invention is applied.

Referring to FIG. 1, a Mobile Station (MS) 10, connected to a UMTS (Universal Mobile Telecommunications System) Terrestrial Radio Access Network (UTRAN) 20, processes voice and data calls and supports both Circuit Service (CS) and (Packet Service (PS). Although not illustrated, the UTRAN 20 includes a Base Station (BS) (or Node B) and a Radio Network Controller (RNC). The base station is connected to the MS 10 via a Uu interface, and the RNC is connected to a core network 30 via an Iu interface. The core network 30 includes a Serving GPRS (General Packet Radio Service) Support Node (SGSN) 32 and a Gateway GPRS Support Node (GGSN) 34.

The UTRAN 20 performs protocol translation on the radio data or control messages transmitted from the MS 10 over the air according to a GPRS Tunneling Protocol (GTP). GPRS is packet data service performed in a UMTS network.

The SGSN 32, a service node for managing subscriber information and location information of the MS 10, is connected to the UTRAN 20 via the Iu interface and to the GGSN 34 via a Gn interface and exchanges data and control messages with them. Further, the SGSN 32 is connected to a Home Location Register (HLR) 36 via a Gr interface and registers therein its subscriber information and location information.

The HLR 36 stores subscriber information and routing information of packet domains, and is connected to the GGSN 34 via a Gc interface. The HLR 36 may also be located in another network (not shown) taking into account the roaming of the MS 10.

The GGSN 34 is an access point corresponding to a GTP-based end node in a UMTS network, and acts as a gateway node that can interact with such external networks as the Internet 40, a Packet Domain Network (PDN) or a Public Land Mobile Network (PLMN), via a Gi interface. The GGSN 34 stores therein Packet Data Protocol (PDP) addresses and routing information, i.e., SGSN addresses, of packet data service subscribers. The routing information is used for tunneling the data traffic from the Internet 40 to the current switching point, i.e., SGSN, of the MS 10.

In order to access a packet data service, an MS first establishes a logical link to an SGSN that covers the region where the MS is located. At this moment, the SGSN creates a PDP context for the MS and performs an authorization and authentication procedure for the MS. The PDP context includes not only status and location information of the MS but also information necessary for the packet data service.

In order to transmit/receive traffic data, the MS requests a PDP Activation procedure to activate a desired packet data address, i.e., an IP address. This operation is first performed between the MS and its associated GGSN, and at this time, interaction with the external system, i.e., the Internet, is started. Specifically, the PDP context is created in the MS, the GGSN and the SGSN.

An MS in an idle or standby state can have one or more PDP contexts. The PDP context defines such different data transmission parameters as a PDP type such as X.25 or IP, a PDP address such as an X.121 address, a QoS, a Network Service Access Point Identifier (NSAPI), and an Access Point Name (APN).

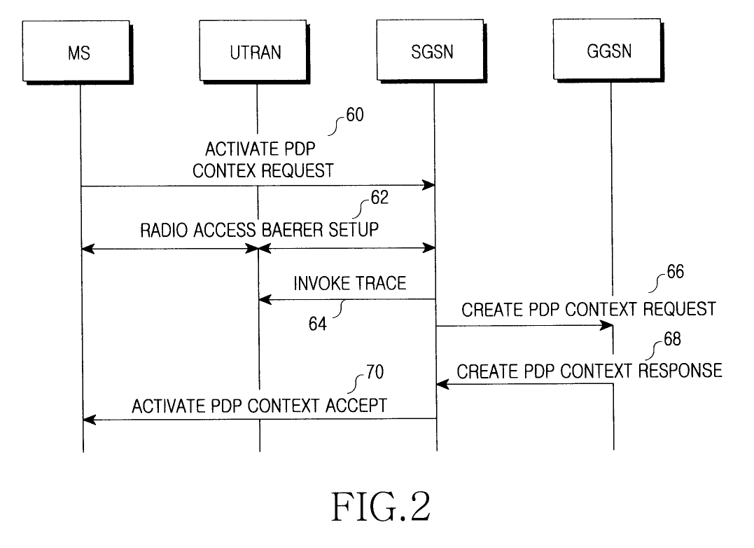

Next, with reference to FIG. 2, a description will be made of an operation of activating a PDP context to access packet data service. FIG. 2 is a message flow diagram illustrating a PDP context activation procedure. The PDP context activation procedure is performed after a GPRS Attach procedure is performed.

In a UMTS packet domain, a GTP tunnel is created to transmit data traffics. The GTP tunnel created through the PDP Activation procedure is mapped to its unique PDP context. The GTP tunnel is created in the following two different processes: an MS-initiated activation process in which the MS sends an activation request to a UMTS core network, and a network requested activation process in which an external system sends an activation request to the UMTS core network. Herein, the GTP tunnel is created in the MS-initiated activation process.

Referring to FIG. 2, the MS transmits an Activate PDP Context Request message to an SGSN to set up a call for packet data service in step 60. The parameters contained in the Activate PDP Context Request message include NSAPI, Transaction Identifier (TI), PDP type, PDP address, APN, and QoS attribute.

The NSAPI is information generated in the MS, and a total of 11 NSAPI values of #5 to #15 can be used. The NSAPI value is mapped to a PDP address and a PDP context IDentifier (ID) on a one-to-one basis, and is uniquely assigned to each of the GTP tunnels to distinguish between the GTP tunnels. The PDP address indicates an IP address of an MS, used in the UMTS domain, and includes information used for distinguishing the PDP context information. The PDP context stores therein various information on the GTP tunnel, and is managed by a PDP context ID.

The TI is used in the MS, the UTRAN and the SGSN, and has a unique value for each individual GTP tunnel to distinguish each GTP tunnel. The NSAPI, unlike the TI, is used in the MS, the SGSN and the GGSN.

The PDP type indicates a type of the GTP tunnel desired to be created through the Activate PDP Context Request message. The types of the GTP tunnels include IP, Point to Point Protocol (PPP), and Mobile IP. The APN indicates an access point of a service network that an MS requesting the creation of the GTP tunnel desires to access.

The QoS indicates a requested QoS class of the packet data transmitted over the currently created GTP tunnel. The packet data using a GTP tunnel with a high QoS class is preferentially processed compared with the packet data using a GTP tunnel with a low QoS class.

Upon receiving the Activate PDP Context Request messages the SGSN transmits a Radio Access Bearer Setup message to the MS via a UTRAN to set up a radio access bearer in step 62. As the radio access bearer is set up between the SGSN and the UTRAN and between the UTRAN and the MS, the resources necessary for transmission of packet data through the radio access bearer are allocated.

When a trace function is activated in the UTRAN, the SGSN transmits an Invoke Trace message to the UTRAN along with trace information acquired from an HLR or an Operation and Maintenance Center (OMC) in step 64. The trace function is used for tracing a flow of data.

After setting up the radio access bearer via the UTRAN, the SGSN transmits a Create PDP Context Request message to a GGSN in step 66. An address of the GGSN can be indicated by an APN included in the Activate PDP Context Request message. If in the Activate PDP Context Request message dose not contain an APN, or the APN included therein does not indicate a valid GGSN address, an appropriate GGSN is selected by the SGSN. In step 66, a GTP tunnel of a core network is created. At this moment, a Tunnel Endpoint ID (TEID) is newly set up between the SGSN and the GGSN. The TEID is set up to transmit packet data between network nodes that use the GTP tunnel. That is, the SGSN stores therein the TEID of the GGSN, and the GGSN stores therein the TEID of the SGSN. The Activate PDP Context Request message includes therein a TEID that should be used when the GGSN transmits packet data to the SGSN.

After a successful completion of creating the PDP context in response to the Create PDP Context Request message, the GGSN transmits a Create PDP Context Response message to the SGSN in step 68. In this way, a GTP tunnel is created between the SGSN and the GGSN, and packet data can be actually transmitted through the GTP tunnel. The TEID used to transmit data from the SGSN and the GGSN is included in the Create PDP Context Response message.

Upon receiving the Create PDP Context Response message, the SGSN transmits an Activate PDP Context Accept message to the MS in step 70. As the MS receives the Activate PDP Context Accept message, a radio path is created between the MS and the UTRAN, completing the creation of a GTP tunnel between the UTRAN and the GGSN via the SGSN. In this manner, the MS can transmit and receive all packet data having its own PDP address via the GTP tunnel.

As described in connection with FIG. 2, the MS transmits QoS information to the UTRAN at an initial phase where it attempts a call to receive packet service, and the QoS information is delivered back to the MS after undergoing negotiation between the UTRAN, the SGSN and the GGSN. At this time, the SGSN may undergo a process of acquiring, from the HLR, a QoS allowed when a subscriber of the MS subscribes to WCDMA and comparing the acquired QoS with the currently requested QoS. The QoS information includes a maximum up/down bit rate and a guaranteed up/down bit-rate. Radio resources for the MS are allocated according to a bit rate based on the negotiated QoS profile, and the SGSN/GGSN performs Differential QoS Services (DiffServ QoS) according to the QoS policy.

In order for the subscriber to use File Transfer Protocol/Hyper Text Transfer Protocol (FTP/HTTP)/Wireless Access Protocol (WAP) services after setting up a call and accessing the network, the TCP which is an end-to-end transport layer protocol is used. In the UMTS network, a TCP end node corresponds to an MS and a GGSN. Through the PDP context activation of FIG. 2, the GGSN allocates bandwidths for uplink/downlink TCP transmission. When bidirectional simultaneous transmission is achieved, the GGSN sets up a TCP session for the uplink and a TCP session for the downlink, and the sessions independently operate with the allocated bandwidths.

The TCP is a connection-oriented protocol based on the Internet protocol (IP). This means that a client-server should undergo a connection establishment process. In addition, a TCP/IP suite segments data before transmission, and performs a checksum check, Sequence Number (S/N) check, and data corruption check. The TCP is a reliable transport mechanism that sends a recipient a request not only for an ACK but also for completeness and a sequence number.

The TCP uses a port number for inter-process communication, and supports flow control and error control that a transport layer protocol can provide. The TCP uses a sliding window protocol for the flow control, and uses a TCP timer and retransmission in addition to the checksum, for the error control.

The TCP flow control refers to a process in which a reception side adjusts and defines a data rate of a transmission side. The TCP uses a buffer to store the data delivered from an application program, and defines a window to determine a size of the transmission data. The TCP can transmit as much data as the number of bytes defined in the window. For such flow control, the TCP uses a sliding window technique.

In order to control congestion occurring in the network, the TCP provides congestion control for an end node. The TCP congestion control is used to efficiently perform retransmission when there is a packet drop in a transmission side due to the congestion in the network. A TCP transmission side uses a slow start algorithm to probe the bandwidth of the current network and if there is a packet drop, the TCP transmission side retransmits the lost packet and recovers the data rate through a congestion avoidance process.

The GGSN according to a preferred embodiment of the present invention determines whether each incoming packet is a TCP packet or a TCP ACK packet. If the incoming packet is a TCP ACK packet, the GGSN estimates/predicts current and future bit rates. If the estimated/predicted bit rate has reached a threshold not exceeding the allowed maximum bit rate, the GGSN restricts a data rate of a reception side of the TCP ACK packet (i.e., a transmission side of the data packet). This is done to restrict the transmission of packet traffics because of the delay in the transmission of the TCP ACK. The threshold is determined such that the predicted bandwidth can maintains a residual bandwidth sufficient to allow the transmission of the TCP ACK packet, within the allowed maximum bandwidth for the corresponding link. That is, the threshold is a value obtained by subtracting a transmission bandwidth for the transmission of the TCP ACK packet from the maximum bandwidth, and can be determined experimentally according to the size and the interval of the TCP ACK packet. In this way, the GGSN restricts a bandwidth of one link such that it does not exceed the maximum bandwidth, so the TCP ACK packets of the opposite link can be transmitted through the remaining residual resources.

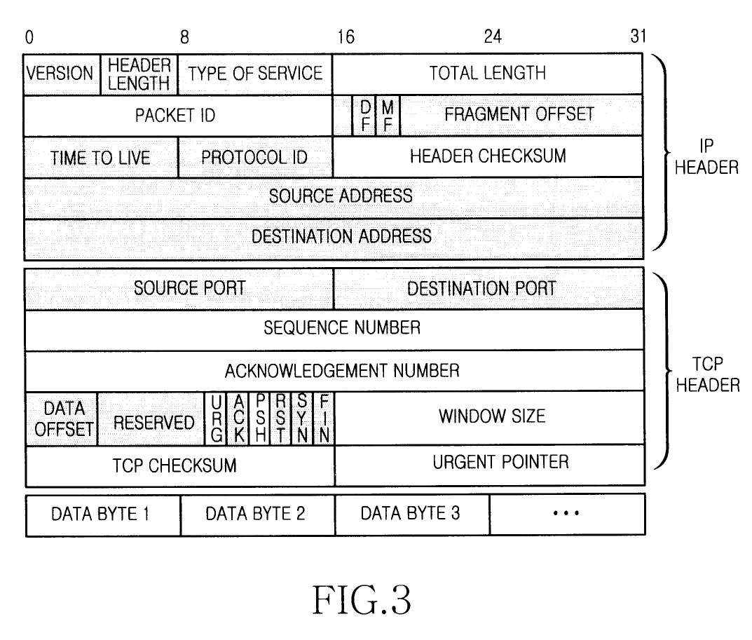

The GGSN determines whether an incoming packet is TCP data or TCP ACK data, based on a header of the incoming packet. A format of a header used in the IP-based TCP is illustrated in FIG. 3.

As illustrated in FIG. 3, the TCP/IP header includes an IP header and a TCP header.

The IP header will first now be described. A 4-bit Protocol Version indicates a format of an Internet header. Herein, a format of Version 4 disclosed in Request For Comments (RFC) 791 will be described. A 4-bit Header Length is a length of the Internet header, and indicates a start of data. A Type Of Service is 8-bit information indicating a desired service quality in terms of delay, reliability and throughput. A 16-bit Total Length indicates a length of the packet (header and data) estimated in units of bytes. A Packet Identifier is a 16-bit identifier value allocated in a transmission side to assemble fragments of datagram. Of 3 1-bit flags, a first flag of a reserved bit is set to ‘0’, Don't Fragment (DF) of a second bit indicates whether it is a fragment, and Mail Forwarder (MF) of a third bit indicates whether it is the last segment. A 13-bit Fragment Offset indicates to which position of a datagram the corresponding fragment belongs. A Time To Live (TTL) indicates the maximum time with 8 bits, for which the corresponding datagram can remain. An 8-bit Protocol Identifier indicates a protocol (e.g. TCP) used in a data part of the datagram. A 16-bit Header Checksum is error correction information only for the header. A Source Address and a Destination Address indicate 32-bit LP addresses of a source node and a destination node, respectively. Of the information, the variable information includes the Total Length, the Packet Identifier, and the Header Checksum.

Next, the TCP header will be described. A Source Port Address and a Destination Port Address, each of which has 16 bits, indicate port numbers of application programs mapped to a source node and a destination node for transmitting/receiving segments. A 32-bit Sequence Number indicates a number assigned to a first byte (i.e., octet) of data included in the segment. The TCP creates an Initial Sequence Number (ISN) by a random generator during connection establishment. Further, the TCP assigns a sequence number to every transmission byte and indicates a first byte of the segment using the sequence number, in order to guarantee reliable connection.

A 32-bit Acknowledgement Number is a sequence number that a transmission side of the segment expects to receive from its counterpart reception side. That is, if the reception side receiving the segment has successfully received a byte N, the reception side writes N+1 in the Acknowledgement Number field before transmission to the transmission side. The acknowledgement and data can be piggybacked.

A 4-bit Header LENgth (HLEN) represents a length of the TCP header in the number of 4-byte words. Because the header length ranges between 20 and 60 bytes, the HLEN ranges from 5 to 12. A 6-bit Reserved field is set to ‘0’.

Control Flags include 6 flags of URG, ACK, PSH, RST, SYN and FIN, used for determining a type of a standard TCP ACK. The Control Flags have the following meanings, and when a value of each Control Flag is set to ‘1’, it means ‘set’, i.e., ‘true’.

URG (Urgent Pointer): It indicates validity of an Urgent Pointer field.

ACK (Acknowledge): It indicates validity of a value of an ACK field. ACK flags for a data packet and an ACK packet except for initialization and synchronization packets are set to ‘1’.

PSH (Push): It indicates whether a ‘Push’ function is requested.

RST (Reset): It indicates that connection reset is requested.

SYN (Synchronization): It indicates that a corresponding packet is a synchronization packet for synchronizing sequence numbers.

FIN (Final): It indicates that there is no more transmission data at the transmission side.

A 16-bit Window Size is the maximum size of the sequence number that the transmission side can accept, and becomes a window size in bytes, which should be maintained at the reception side. The Window Size is an Advertised window size (Adv_win) requested by the reception side, and the maximum value of the Window Size is 65535.

A 16-bit TCP Checksum is a checksum of the header and data. A 16-bit Urgent Pointer indicates a sequence number of the succeeding urgent data according to the URG flag.

Herein, an embodiment of the present invention will be described in detail with reference to an exemplary WCDMA system that allocates a broader bandwidth for the downlink, compared with the uplink. However, the present invention is not limited to such an example, and can be applied to every type of the communication system that allocates a broader bandwidth for one link compared with the other link and uses the TCP for both links. In the following description, a link for transmitting data packets will be referred to as a forward link and a link for transmitting ACK packets for the data packets will be referred to as a reverse link. In addition, it will be assumed herein that a process of the present invention is performed by a gateway node which is a TCP end node of the network.

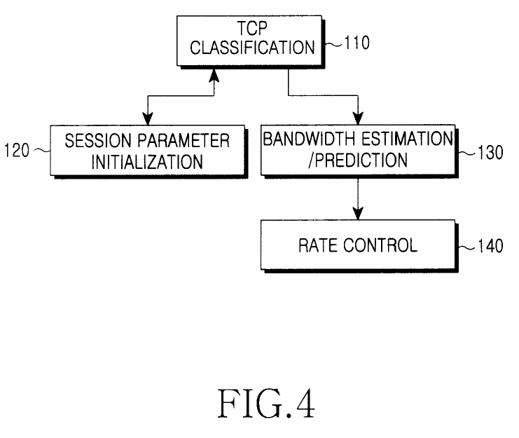

FIG. 4 is a diagram illustrating a structure of a gateway node according to a preferred embodiment of the present invention. Herein, FIG. 4 illustrates only the part of performing TCP transmission control during bidirectional simultaneous transmission in the gateway node.

Referring to FIG. 4, the gateway node includes a TCP classification module 110, a session parameter initialization module 120, a bandwidth estimation/prediction module 130, and a rate control module 140.

The TCP classification module 110 checks an IP protocol field (Protocol ID of FIG. 3) of an incoming packet to find a packet with a transport layer protocol=TCP. For a TCP packet, the TCP classification module 110 manages the TCP packet using source and destination IP addresses and source/destination port number as a key. The TCP classification module manages a corresponding TCP session by classifying SYN, ACK and FIN flags for each individual TCP packet.

The session parameter initialization module 120 calculates an Initial Emulated Congestion Window (init_emul_cwnd) The session parameter initialization module 120 determines the init_emul_cwnd according to the amount of packets transmitted for data transmission over a forward channel until a first data transmission ACK after TCP 3-way handshake is received. In addition, the session parameter initialization module 120 stores a size of a first data transmission packet as an emulated Maximum Transfer Unit (MTU). An Emulated Congestion Window (emul_cwnd) increases by the amount of ACKed packets each time an ACK is transmitted over a reverse channel. That is, the emul_cwnd increases in a slow start state in the manner in which a cwnd of a transmission side increases. The determined parameters of emul_cwnd and MTU size are provided to the bandwidth estimation/prediction module 130 by the TCP classification module 110.

The bandwidth estimation/prediction module 130 estimates a bandwidth currently maintained in each TCP session each time an ACK transmitted over a reverse channel passes through a gateway node or each time data transmitted over a forward channel passes through the gateway node using a possible bandwidth estimation method. Based on the estimated bandwidth, the bandwidth estimation/prediction module 130 predicts a bandwidth for the next several sample packets. In this case, the bandwidth estimation/prediction module 130 uses an emul_cwnd as a prediction range. That is, the bandwidth estimation/prediction module 130 regards as the emul_cwnd the prediction range where the ACK currently passing therethrough may affect the next bandwidth, and iteratively performs the estimation on the assumption that there will be packet transmission with the same characteristic for the prediction range. If the bandwidth predicted during the prediction, i.e., iteration of the estimation, reaches a predetermined specific amount, i.e., an upper threshold, less than the maximum bandwidth allocated to the subscriber, the bandwidth estimation/prediction module 130 provides the corresponding information to the rate control module 140 so that the transmission side reduces a TCP transmission rate.

The rate control module 140 converts the ACK packet transmitted over the reverse channel from the reception side via the gateway node so that the transmission side may reduce the TCP transmission rate. Converting the ACK packet on the reverse channel can be achieved by modifying an Advertised window size (Adv_win) included in the ACK packet. That is, the rate control module 140 selects an optimal window size (optimal_win) using a predicted iteration at the time when the estimated bandwidth reaches the specific amount, and replaces the selected optimal window size with the Adv_win include in the ACK packet. The rate control module 140 can restrict the data rate of the transmission side using the optimal window size.

Once the data rate for the optimal window size is determined, the rate control module 140 converts ACK packets on the reverse channel so that the data rate is maintained. If the bandwidth estimation/prediction module 130 fails in the prediction, the rate control module 140 reattempts to modify the Advertised window size.

The bandwidth estimation/prediction module 130 assumes that there will be packet transmission with the same characteristic for a particular prediction range during bandwidth estimation. Therefore, when the foregoing assumption is wrong, a bandwidth prediction failure occurs. If the bandwidth prediction failure occurs, the data rate of the transmission side may be dramatically decreased by the rate control module 140. To address this problem, the bandwidth estimation/prediction module 130 prepares for the bandwidth prediction failure as follows.
The bandwidth estimation/prediction module 130 detects the bandwidth prediction failure when a bandwidth less than a predetermined lower threshold is maintained for 2-sample time after the bandwidth prediction.
The rate control module 140 recalculates an optimal window size using a predicted iteration at the previous sample when the calculated optimal advertised window size is less than an initial emulated congestion window.

In this operation, TCP transmission uses only the bandwidth determined by the upper threshold less than the maximum bandwidth allocated to the subscriber based on the optimal window size. When the algorithm of the present invention is performed for uplink/downlink simultaneous transmission, TCP transmission is achieved in each transmission direction at a constant data rate less than the upper threshold. Transmission of the ACK packets for the data packets in the opposite direction is possible through the remaining bandwidth. In this way, even during the bidirectional simultaneous transmission, transmission at the fixed data rate is guaranteed without being interfered by transmission in each direction.

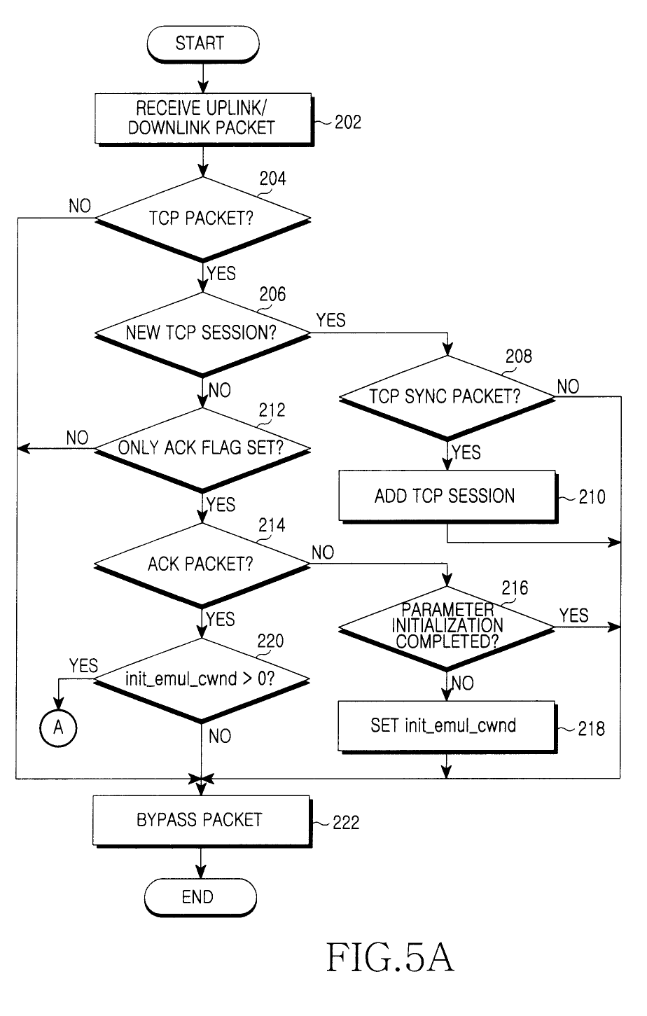

FIGS. 5A and 5B are flowcharts illustrating an operation of a gateway node according to a preferred embodiment of the present invention. In FIGS. 5A and 5B, a TCP classification module 110 performs steps 202 to 210, a session parameter initialization module 120 performs steps 212 to 226, a bandwidth estimation/prediction module 130 performs steps 228 to 250, and a rate control module 140 performs step 252. The following steps can be performed during bidirectional simultaneous transmission in the gateway node.

Referring to FIG. 5A, the TCP classification module 110 receives an uplink/downlink packet received at the gateway node in step 202. A format of the packet has been illustrated in FIG. 3. The TCP classification module 110 determines in step 204 if the packet is a TCP packet based on a protocol ID of the packet. If the packet is not a TCP packet, the packet is bypassed in step 222. However, if the packet is a TCP packet, the TCP classification module 110 proceeds to step 206.

The TCP classification module 110 determines in step 206 whether the TCP packet is related to a new TCP session or an old TCP session. Whether the TCP session was previously set up is determined by checking a source IP address, a destination IP address, a source port number and a destination port number of the TCP packet. That is, the TCP classification module 110 compares the source IP address, the destination IP address, the source port number and the destination port number of the TCP packet with their associated TCP session entries in an old TCP session entry list. If there is any identical TCP session entry, the TCP classification module 110 determines that there is an old TCP session related to the TCP packet. If there is the old TCP session related to the TCP packet, the TCP classification module 110 proceeds to step 212. However, there is no old TCP session related to the TCP packet, the TCP classification module 110 proceeds to step 208, determining that the TCP packet is related to a new TCP session.

The TCP classification module 110 determines in step 208 if only the SYN flag among the flags of the TCP packet is set to ‘1’. Herein, setting only the SYN flag to ‘1’ means that the TCP packet is a TCP synchronization packet used for parameter initialization of the TCP session. Therefore, in step 210, the TCP classification module 110 adds source/destination IP/port values included in the TCP packet to the TCP session entry list as new TCP session entries, and then proceeds to step 222 where it bypasses the TCP packet. However, if the TCP packet is not the TCP synchronization packet, the TCP classification module 110 proceeds to step 222, determining that the TCP packet is an abnormal packet. In this case, the TCP packet is appropriately processed in the destination node.

In step 212, the session parameter initialization module 120 receives the TCP packet from the TCP classification module 110 and determines if only the ACK flag among the flags of the TCP packet is set to ‘1’. If only the ACK flag is set, the session parameter initialization module 120 proceeds to step 214. However, if the ACK flag is not set or a flag other than the ACK flag is set, the session parameter initialization module 120 proceeds to step 222 where the TCP packet is bypassed.

The session parameter initialization module 120 determines in step 214 whether the TCP packet is a data packet or an ACK packet for data transmission. Herein, whether the TCP packet is an ACK packet can be determined through packet inspection of a size of the TCP packet. If the TCP packet is not the ACK packet, the session parameter initialization module 120 determines in step 216 if the session parameter initialization for the TCP session related to the TCP packet has been completed. The determination of step 216 can be made according to whether an initial_emul_cwnd_found_flag indicating completion of the session parameter initialization is set to ‘ON’. The initial_emul_cwnd_found_flag can be referred by the session parameter initialization module 120 or the TCP classification module 110, and a description of its setting method will be described below.

If the session parameter initialization has been completed, the session parameter initialization module 120 proceeds to step 222 where the TCP packet data is bypassed. However, if the session parameter initialization has not be completed, the session parameter initialization module 120 increases an initial emulated congestion window init_emul_cwnd of the TCP session related to the TCP packet data by a length value ‘iph->length’ in a IP header of the TCP data packet in step 218. Herein, the init_emul_cwnd is set to an initial value ‘0’ when the corresponding TCP session first starts, and the init_emul_cwnd increases by a data length of the TCP packet as in step 218 each time the associated TCP data packet is transmitted. After step 218, the session parameter initialization module 120 proceeds to step 222 where the TCP data packet is bypassed.

However, if the TCP packet is an ACK packet in step 214, the session parameter initialization module 120 determines in step 220 whether the init_emul_cwnd of the TCP session related to the TCP packet is greater than ‘0’. This is to determine if the init_emul_cwnd is normally set. If the init_emul_cwnd is not greater than ‘0’, the session parameter initialization module 120 proceeds to step 222, determining that the init_emul_cwnd is abnormally set. In this case, the TCP ACK packet is appropriately processed in the destination node. However, if the init_emul_cwnd is greater than 0, i.e., if the init_emul_cwnd is normally set, the session parameter initialization module 120 proceeds to step 224.

Referring to FIG. 5B, the session parameter initialization module 120 determines in step 224 if the session parameter initialization has been completed, based on the initial_emul_cwnd_found_flag. If the initial_emul_cwnd_found_flag is not set to ‘ON’, the session parameter initialization module 120 sets in step 226 the init_emul_cwnd to the emul_cwnd, and sets initial_emul_cwnd_found_flag to ‘ON’, indicating the completion of the session parameter initialization. The emul_cwnd is used as a prediction range in the next bandwidth prediction process. However, if the initial_emul_cwnd_found_flag has already been set to ‘ON’, the session parameter initialization module 120 proceeds to step 228.

The bandwidth estimation/prediction module 130 determines in step 228 if the TCP ACK packet is a Duplicate ACK, based on the sequence number in the TCP ACK packet. Herein, the term “Duplicate ACK” refers to an ACK that is retransmitted because the TCP ACK packet is lost in the previous transmission.

If the TCP ACK packet is a retransmitted packet, the emul_cwnd is maintained at the init_emul_cwnd in step 230. However, if the TCP ACK packet is not a retransmitted packet, the emul_cwnd increases by an ACKed byte value, i.e., a transmitted byte value transmitted_bytes, compared with the previous emul_cwnd in step 232. The transmitted byte value can be determined according to a difference between an ACK number of the TCP ACK packet and its previous ACK number. Herein, the term “ACK number” refers to a sequence number of a data packet mapped to an ACK packet. Steps 226, 230 and 232 proceed to step 234.

In step 234, the bandwidth estimation/prediction module 130 estimates a bandwidth at the current time for the forward link mapped to the TCP ACK packet according to a predetermined estimation process. The bandwidth estimation process estimates an instantaneous bandwidth at the current time when the TCP ACK packet was received.

The bandwidth estimation/prediction module 130 determines in step 236 if an optimal window value optimal_win for bandwidth restriction has already been determined. The optimal_win is provided to restrict the bandwidth of the destination mode that receives the TCP ACK packet. If the optimal_win has already been determined, the bandwidth estimation/prediction module 130 proceeds to step 252. Otherwise, the bandwidth estimation/prediction module 130 performs steps 238 to 250 to determine the optimal_win.

In step 238, the bandwidth estimation/prediction module 130 calculates an iteration for bandwidth prediction, which indicates the prediction range, using the emul_cwnd. Herein, the iteration is determined by dividing the emul_cwnd by a predetermined Maximum Transfer Unit (MTU) size MTU_size of the current TCP session. Further, in step 238, ‘i’ indicating a bandwidth prediction count is set to 0.

The bandwidth estimation/prediction module 130 determines in step 240 if the prediction count i is less than the iteration. If the prediction count i reaches the iteration in step 240, with the Bandwidth predication (Bw_pred(i)) not exceeding the limit th_high of the bandwidth that the subscriber can maximally use, then the prediction count i, i.e., the iteration, is stored as the last recommended optimal window value last_recommend_optimal_window in step 242. At this moment, the TCP ACK packet is bypassed without being modified. However, if the prediction count i is less than the iteration, the bandwidth estimation/prediction module 130 predicts in step 244 the future bandwidth Bw_pred(i) according to a predetermined prediction algorithm on the assumption that packets having the same characteristics as the current packets have been received. A detailed description of the prediction algorithm will be omitted because it is not closely related to the understanding of the present invention.

The bandwidth estimation/prediction module 130 determines in step 246 if the Bw_pred(i) is greater than or equal to the th_high. The th_high is limited such that ACK packet reception in the opposite direction is possible during bidirectional simultaneous FTP transmission in the asymmetric bandwidth link. If the Bw_pred(i) is less than the th_high, the bandwidth estimation/prediction module 130 increases the prediction count i by 1 in step 248, and then returns to step 240. However, if the Bw_pred(i) is greater than or equal to the th_high, the bandwidth estimation/prediction module 130 proceeds to step 250 where it determines the optimal_win. In step 250, the optimal_win is determined as a value obtained by multiplying the greater of the last recommended optimal window value last_recommend_optimal_window and the prediction count i by the MTU size MTU_size. The optimal_win cannot exceed a maximum window value max_cwnd predetermined for the TCP. Once the optimal_win is determined, the bandwidth estimation/prediction module 130 proceeds to step 252.

In step 252, the rate control module 140 replaces the advertised window size Adv_win included in the TCP ACK packet with the optimal_win and forwards the resultant optimal_win to the destination node. The destination node transmits data packets of the TCP session mapped to the TCP ACK packet within the optimal_win. This means that the destination node does not transmit excessive data packets without the TCP ACK.

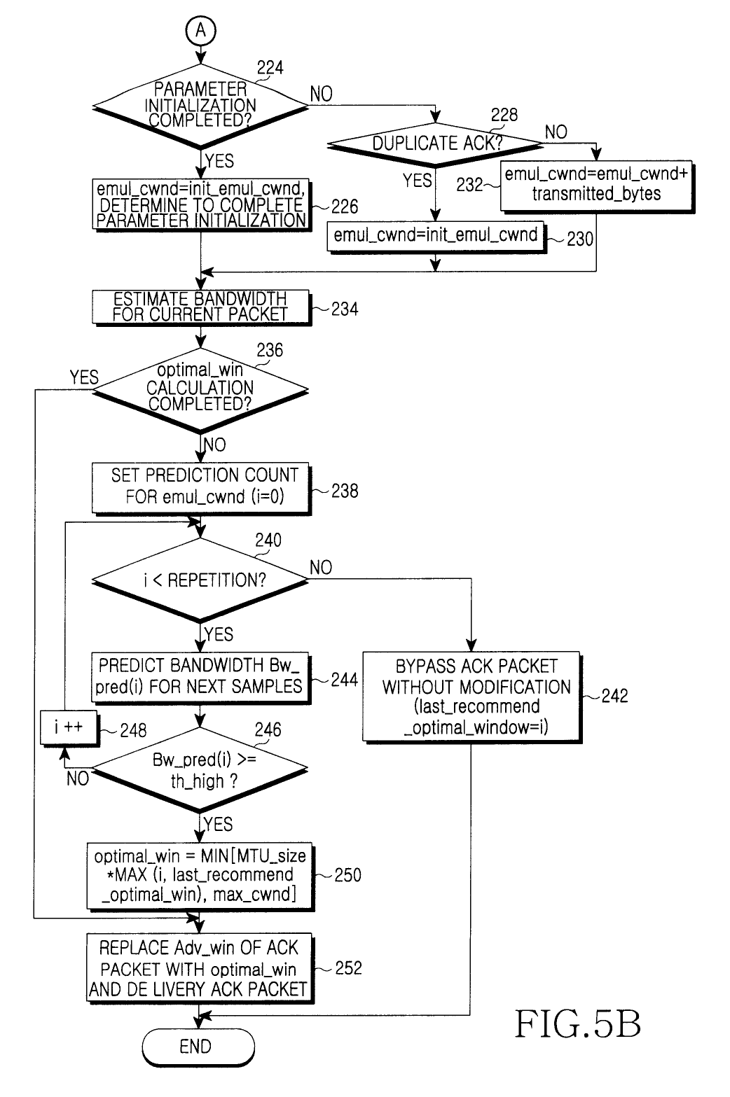

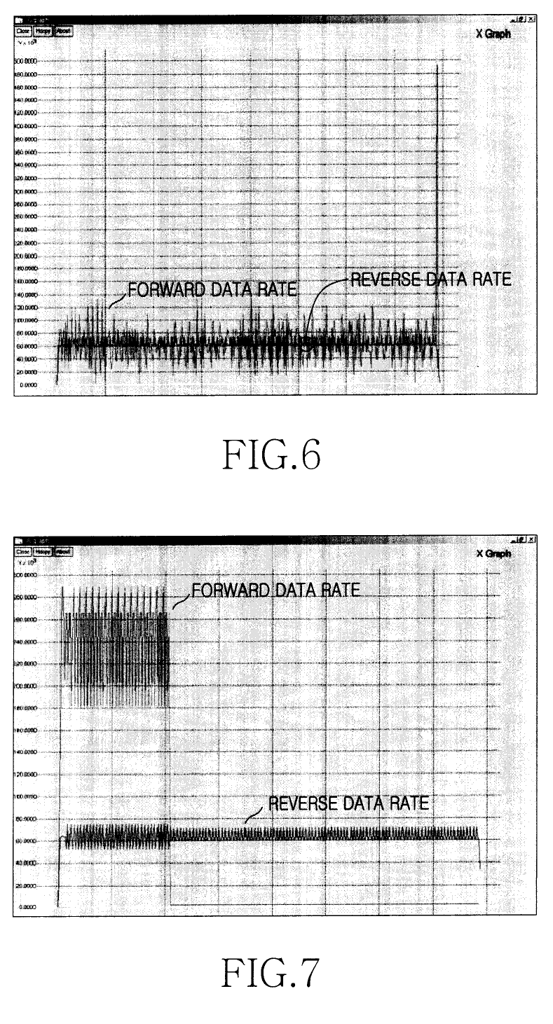

FIGS. 6 and 7 illustrate a change in uplink/downlink data rate in the prior art and the present invention, respectively. A forward data rate and a reverse data rate are labeled thereon.

Referring to FIG. 6, the forward data rate is synchronized with a similar level of the reverse data rate. However, referring to FIG. 7, the forward data rate maintains a level of the data rate allocated without being affected by the reverse data rate.

Table 1 below shows the simulation result showing an improvement of the downlink bandwidth according to the present invention, in the GGSN of the WCDMA system using a 64/384 Kbps asymmetric bandwidth link.

TABLE 1

| | Conventional | Proposed |
|---|---|---|
| | (UL/DL = 64/384 kbps) | (UL/DL = 64/384 kbps) |
| Average uplink rate | 58.93 kbps | 52.85 kbps |
| Average downlink | 54.08 kbps | 337.1 kbps |
| rate | | |

As shown in Table 1, in the conventional technology, the downlink rate is synchronized to 54.08 Kbps which is a level similar to that of the uplink rate. However, in the present invention, the downlink rate maintains 377.1 Kbps approaching 384 Kbps which is the maximum bandwidth allocated without being affected by the uplink rate.

Although the operation in the gateway node which is a relay node has been described, the process of the present invention described with reference to FIGS. 5A and 5B can also be applied to an end node, for example, a terminal. In other words, when a terminal, which is allocated an asymmetric bandwidth and uses the asymmetric bandwidth for TCP transmission, attempts bidirectional TCP simultaneous transmission, the terminal restricts the data rate by adjusting the advertised window size included in each ACK packet such that TCP ACK packets can be transmitted, thereby solving the rate decrease problem during simultaneous transmission.

Specifically, referring to FIG. 5A, the terminal generates an IP packet to be transmitted to a destination node via the network, and then performs steps 204 to 252 for the generated IP packet. That is, the terminal generates an ACK packet to be transmitted over the reverse link, and then replaces the advertised window size Adv_win of the ACK packet with an optimal window size optimal_win determined in steps 224 to 250, before transmission, or bypasses the ACK packet without modification. In this way, the terminal allows the bandwidth of the forward link to have a residual bandwidth enough to transmit the ACK packet.

In this manner, the terminal and the gateway node acquire an IP packet to be transmitted to the destination node, and then perform steps 204 to 252 on the acquire IP packet.

As described above in detail, the present invention has the following advantages.

The present invention restrictively uses a predetermined TCP transmission bandwidth during TCP transmission, thereby preventing inevitable packet drop, i.e., congestion, due to the slow start and congestion avoidance which are the characteristics of the TCP transmission.

In addition, during bidirectional simultaneous transmission in the TCP asymmetric bandwidth link, only the bandwidth determined by the limited data rate is used for each uplink/downlink transmission, preventing throughput sync due to the ACK clocking. That is, the present invention smoothly transmits ACKs in the opposite direction through the residual bandwidth for each uplink/downlink transmission, contributing to an increase in bandwidth efficiency.

While the invention has been shown and described with reference to a certain preferred embodiment thereof, it will be understood by those skilled in the art that various changes in form and details may be made therein without departing from the spirit and scope of the invention as defined by the appended claims.

1. A transmission control method for bidirectional simultaneous transmission of a transport control protocol (TCP) in a subscriber network with asymmetric bandwidth links, the method comprising the steps of:
acquiring a TCP acknowledgement (ACK) packet to be transmitted over a reverse link during bidirectional simultaneous transmission;
estimating a bandwidth of a forward link mapped to the reverse link at a time when the ACK packet is acquired;
predicting a next bandwidth of the forward link according to the estimated bandwidth, and calculating an optimal window size of the forward link such that the predicted bandwidth maintains a residual bandwidth enough to allow transmission of an ACK packet over the forward link, the predicted bandwidth being less than the maximum bandwidth allocated to the forward link; and
inserting the calculated optimal window size as a reception window size included in the ACK packet and delivering the ACK packet to a destination node.

2. The transmission control method of claim 1, wherein the ACK packet acquiring step comprises creating the ACK packet in an end node of the subscriber network.

3. The transmission control method of claim 1, wherein the bandwidth estimation step comprises:
estimating a bandwidth of the forward link at a time when the ACK packet is received; and
iteratively predicting the bandwidth of the forward link based on the estimated bandwidth while counting a prediction count.

4. The transmission control method of claim 3, wherein the optimal window size calculation step comprises:
if the predicted bandwidth does not exceed the maximum bandwidth until the prediction count reaches a predetermined iteration, storing the iteration as a last recommended optimal window value of an optimal window; and
if the predicted bandwidth reaches the maximum bandwidth before the prediction count reaches the iteration, calculating the optimal window size by multiplying a greater one of the prediction count and the last recommended optimal window value stored for a previous ACK packet by a predetermined maximum transfer unit (MTU) size.

5. The transmission control method of claim 4, wherein the iteration is determined by dividing an emulated congestion window value indicating an amount of data for ACKed packets including the ACK packet by the MTU size.

6. The transmission control method of claim 5, wherein the optimal window size is set such that it does not exceed a predetermined maximum congestion window value.

7. The transmission control method of claim 4, further comprising, if the predicted bandwidth does not exceed the maximum bandwidth until the prediction count reaches the iteration, forwarding the reception window size of the ACK packet to the destination node without modification.

8. The transmission control method of claim 1, wherein the ACK packet acquiring step comprises receiving the ACK packet generated by an end node at a gateway node of the subscriber network.

9. The transmission control method of claim 8, wherein the ACK packet acquiring step comprises:
receiving an Internet protocol (IP) packet received at the gateway node and determining if the IP packet is a TCP packet depending on a protocol identifier included in a header of the IP packet;
bypassing the IP packet if the IP packet is not a TCP packet;
if the IP packet is a TCP packet, determining if a TCP session related to the TCP packet already exists in the gateway node according to IP addresses and port numbers of source and destination nodes, included in the TCP packet; and
if the TCP session does not exist, adding the TCP session related to the TCP packet and bypassing the TCP packet.

10. The transmission control method of claim 9, wherein the ACK packet acquiring step comprises:
if the TCP session exists, determining if only an ACK flag among flags included in the TCP packet is set;
if only the ACK flag of the TCP packet is not set, bypassing the TCP packet;
if only the ACK flag of the TCP packet is set, determining whether the TCP packet is an ACK packet or a data packet according to a size of the TCP packet;
if the TCP packet is a data packet, setting an initial emulated congestion window value according to a size of the data packet and bypassing the data packet;
if the TCP packet is an ACK packet, determining if the initial emulated congestion window value is greater than 0; and
if the initial emulated congestion window value is not greater than 0, bypassing the ACK packet.

11. A transmission control apparatus for bidirectional simultaneous transmission of a transport control protocol (TCP) in a subscriber network with asymmetric bandwidth links, the apparatus comprising:
a TCP classification module for acquiring a TCP acknowledgement (ACK) packet to be transmitted over a reverse link during bidirectional simultaneous transmission;
a bandwidth estimation/prediction module for estimating a bandwidth of a forward link mapped to the reverse link at a time when the ACK packet is acquired, predicting a next bandwidth of the forward link according to the estimated bandwidth, and calculating an optimal window size of the forward link such that the predicted bandwidth maintains a residual bandwidth enough to allow transmission of an ACK packet over the forward link, the predicted bandwidth being less than the maximum bandwidth allocated to the forward link; and
a rate control module for inserting the calculated optimal window size as a reception window size included in the ACK packet and delivering the ACK packet to a destination node.

12. The transmission control apparatus of claim 11, wherein the TCP classification module, the bandwidth estimation/prediction module, and the rate control module are included in an end node of the subscriber network.

13. The transmission control apparatus of claim 11, wherein the bandwidth estimation/prediction module:
estimates a bandwidth of the forward link at the time when the ACK packet is received; and
iteratively predicts the bandwidth of the forward link based on the estimated bandwidth while counting a prediction count.

14. The transmission control apparatus of claim 13, wherein the bandwidth estimation/prediction module,
if the predicted bandwidth does not exceed the maximum bandwidth until the prediction count reaches a predetermined iteration, stores the iteration as a last recommended optimal window value of an optimal window; and
if the predicted bandwidth reaches the maximum bandwidth before the prediction count reaches the iteration, calculates the optimal window size by multiplying a greater one of the prediction count and the last recommended optimal window value stored for a previous ACK packet by a predetermined maximum transfer unit (MTU) size.

15. The transmission control apparatus of claim 14, wherein the iteration is determined by dividing an emulated congestion window value indicating the amount of data for ACKed packets including the ACK packet by the MTU size.

16. The transmission control apparatus of claim 15, wherein the optimal window size is set such that it does not exceed a predetermined maximum congestion window value.

17. The transmission control apparatus of claim 14, wherein if the predicted bandwidth does not exceed the maximum bandwidth until the prediction count reaches the iteration, the rate control module forwards the reception window size of the ACK packet to the destination node without modification.

18. The transmission control apparatus of claim 11, wherein the TCP classification module, the bandwidth estimation/prediction module and the rate control module are included in a gateway node of the subscriber network.

19. The transmission control apparatus of claim 11, wherein the TCP classification module:
receives an Internet protocol (IP) packet at the gateway node and determines if the IP packet is a TCP packet depending on a protocol identifier included in a header of the IP packet
bypass the IP packet if the IP packet is not a TCP packet
if the IP packet is a TCP packet, determines if a TCP session related to the TCP packet already exists in the gateway node according to IP addresses and port numbers of source and destination nodes, included in the TCP packet; and
if the TCP session does not exist, adds the TCP session related to the TCP packet and bypassing the TCP packet.

20. The transmission control apparatus of claim 19, further comprising a session parameter initialization module connected to the TCP classification module, the session parameter initialization module,
if the TCP session exists, determines if only an ACK flag among flags included in the TCP packet is set;
if only the ACK flag of the TCP packet is not set, bypasses the TCP packet;
if only the ACK flag of the TCP packet is set, determines whether the TCP packet is an ACK packet or a data packet according to a size of the TCP packet;
if the TCP packet is a data packet, sets an initial emulated congestion window value according to a size of the data packet and bypasses the data packet;
if the TCP packet is an ACK packet, determines if the initial emulated congestion window value is greater than 0; and
if the initial emulated congestion window value is not greater than 0, bypasses the ACK packet.
